(19) United States
(12) Patent Application Publication
(10) Pub. No.: US 2008/0082842 A1
(43) Pub. Date: Apr. 3, 2008

(54) Power supply control circuit of subsystem and subsystem

(75) Inventor: Akira Minami, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/652,784

(22) Filed: Jan. 12, 2007

(30) Foreign Application Priority Data
Sep. 29, 2006 (JP) 2006-266895

(51) Int. Cl. G06F 1/00

(52) U.S. Cl. 713/300

(57) ABSTRACT

The subsystem has, in addition to a USB interface, other interfaces such as a serial ATA. The power control circuit unit has a first changeover circuit which supplies bus power to an internal power terminal by being turned on in the input state of USB bus power from the USB connector, and breaks connection with the internal power terminal by being turned off in the non-input state of the USB bus power, a diode which is insertion-connected to the positive side of the power line from the power input connector, and a second changeover circuit which is connected in parallel to the diode, supplies power of the power input connector to the internal power terminal via the diode by being turned off in the input state of USB bus power, and supplies power from the power input connector, by bypassing the diode, directly to the internal power terminal by being turned on in the non-input state of USB bus power.

This application is a priority based on prior application No. JP 2006-266895 filed Sep. 29, 2006 in Japan.

### BACKGROUND OF THE INVENTION

1. Field of the Invention

The present invention relates to a power supply control circuit of a subsystem having built-in devices such as a hard disk drive which processes an input/output request, externally connected by an interface cable to a host and such a subsystem. More particularly, the invention relates to a power supply control circuit of a subsystem having two interfaces including a USB interface, and in addition, a serial ATA interface, and such a subsystem.

2. Description of the Related Art

Conventionally, as an interface for externally connecting various peripheral devices for a personal computer, USBs (Universal Serial Buses) are widely used. A USB can cause operation by supplying power to peripheral devices by having power supply lines in addition to signal lines and can provide an advantage of not requiring a special power supply for peripheral devices. It is thus popularly used because of the convenience of not requiring a special power supply not only for devices of a small power consumption such as a keyboard, a mouse and a memory stick, but also, more recently, for drive devices such as a hard disk drive and an optical disk drive for external connection.

When operating a USB drive device by bus power, a USB port of a personal computer or a PC-card USB hub does not have in some cases a sufficient current supply ability. In such a case, it is the general practice to use an AC adapter by switching over USB's bus power to power supply from an AC system. It is not however desirable to use an AC adapter from the point of view of the weight and the space when considering an environment in which an AC power supply is not applicable and portability.

For the purpose of solving this problem, the following actions are taken for USB devices such as conventional hard disk drives driven by bus power:

(1) Providing two USB connectors, connecting (directly or via a diode) a positive power line (Vdd line) and a negative power line (Gnd line) from each connector, respectively, and supplying power from two USB connectors, thereby increasing the power supplying capability;

(2) Providing a power connector in addition to the USB connector, and connecting the power cable from the AC adapter to the power connector, thereby increasing the power supplying capability;

An interface for causing a personal computer, on the other hand, to be externally connected to various peripheral devices as subsystems uses, apart from a USB interface, other interfaces such as a serial ATA interface having no power line in some cases. In such a subsystem, a power connector is provided, and power is supplied by connecting a power cable from the AC adapter thereto. There are available the following patent documents: JP No. 2004-213938, and JP No. 2000-284865.

More recently, a subsystem which permits use of two interfaces including a USB interface, and in addition, a serial ATA interface or the like, is conceived as a subsystem to be externally connected to a personal computer. However, since methods for supplying power are different between the two subsystems, it is necessary to solve the problem of supplying power appropriately without causing shortage to the subsystem in correspondence to the state of selective use of two interfaces.

When providing an additional power connector to make up shortage of supplied power based on bus power in the use of a USB interface, and connecting the power USB interface cable to a power connector to supply two systems of bus power, thereby increasing the power supply capability, a difference in potential between two USB connectors may cause a backward flow.

In this case, when using two USB interfaces, the backward flow between ports can be prevented by connecting power lines from the two USB connectors via diodes. When using a serial ATA interface as well, a problem is encountered in that power is supplied from the power connector via a diode, and a voltage drop caused by the diode tends to cause unstable operation of the devices built in the subsystem.

For example, a source voltage of 5.0 V is supplied via a diode, the loss caused by the diode is 0.8 V in the case of a usual silicon diode, and about 0.3 V even in the case of s Schottky diode. As a result, the source voltage supplied to control circuits and diodes in the subsystem drops to 4.2 to 4.7 V. Generally standards specify a source voltage of a hard disk of 5 V ±5%. This specification cannot be satisfied. The threshold value of the circuits operating under a constant voltage becomes unstable along with this voltage drop, and the problem is that there is a higher possibility of causing a malfunction when using a serial ATA interface.

### SUMMARY OF THE INVENTION

It is an object of the present invention to provide a power control circuit for the subsystem permitting appropriate supply of power without causing a supply shortage when selectively using a USB interface supplying bus power and another interface requiring power supply through cable connection, and such a subsystem.

### (Power control circuit of subsystem)

According to the present invention, there is provided a power control circuit of a subsystem having, in addition to a lower-line-holding type interface, another interface, and in addition to two interface connectors corresponding to said two interfaces, a power input connector, comprising:

an IFPL (interface power line) power input terminal for input-connecting a power line from the power-line-holding type interface connector;

a power input terminal which input-connects the power line from the power input connector;

an internal power terminal which supplies power to an internal power circuit;

a first changeover circuit which input-connects the IFPL power input terminal, is turned on in response to an input state of the IFPL bus power, supplies the IFPL bus power to the internal power terminal, and cuts off connection to the internal power terminal by being turned off in response to a non-input state of the IFPL bus power;

a diode which is insertion-connected to the position side of the power line connected from the power input terminal to the internal power terminal; and

a second changeover circuit which is parallel-connected to the diode, supplies power of the power input terminal to the internal power terminal via the diode by being turned off in response to an input state of the IFPL bus power, and supplies power from said power input terminal directly to the internal power terminal, while bypassing the diode by being turned on in response to a non-input state of said IFPL bus power.

In the subsystem, when IFPL bus power is impressed on the IFPL power input terminal by connecting a cable from a host apparatus only to the power-line-holding type interface connector for using the power-line-holding type interface in the subsystem, the first changeover circuit is turned on in response to input of the IFPL bus power, and only IFPL bus power of said IFPL power input terminal is outputted to the internal power terminal by turning off the second changeover circuit (first mode).

In the subsystem, when an IFPL cable having a power line and signal line from a host apparatus is connected to the power-line-holding type interface connector and a power IFPL cable having only a power line from the host apparatus is connected to the power input connector, the first changeover circuit is turned on in response to input of the IFPL bus power of said IFPL power input terminal while turning off the second changeover circuit, and IFPL bus power of the IFPL power input terminal is outputted directly to the internal power terminal while outputting in superposition IFPL bus power of the power input terminal to the internal power terminal via the diode (second mode).

In the subsystem, when, for the purpose of using a power-line-holding type interface in the subsystem, connecting an IFPL cable having a power line and a signal line from the host apparatus to said power-line-holding type interface connector, and connecting a power cable from a power adapter which converts AC power into DC power to the power input connector, the first changeover circuit is turned on and the second changeover circuit is turned off in response to input of the bus power of the power input terminal; IFPL bus power of the IFPL power input terminal is outputted directly to the internal power terminal and power of the power input terminal is outputted in superposition to the internal power terminal (third mode).

In the subsystem, when, for the purpose of using another interface in said subsystem, connecting a cable of another interface from the host apparatus to the other interface connector, and connecting a power IFPL cable having only a power line from said host apparatus to the power input connector, the first changeover circuit is turned off and the second changeover circuit is turned on in response to non-input of IFPL bus power of the IFPL power input terminal; IFPL bus power of the power input terminal is bypassed and outputted directly to said internal power terminal (fourth mode).

In the subsystem, when, for the purpose of using another interface in the subsystem, connecting a cable of another interface from the host apparatus to the other interface connector, and connecting a power cable from a power adapter which converts AC power into DC power to the power input connector, the first changeover circuit is turned off and the second changeover circuit is turned on in response to non-input of IFPL bus power of the IFPL power input terminal; and power of the power input terminal is directly outputted to the internal power terminal by bypassing the diode (fifth mode).

In the power control circuit of the subsystem, the first changeover circuit has a first switching circuit and a first control circuit;

the first switching circuit has a P-type MOS-FET; the drain of the P-type MOS-FET is connected to the IFPL power input terminal; the source is connected to the internal power terminal; and the gate is connected to the output of the first control circuit;

the first control circuit inputs a power voltage of the IFPL power input terminal, and when the power voltage is obtained, turns on the P-type MOS-FET;

the second changeover circuit has a second switching circuit and a second control circuit;

the second switching circuit has a P-type MOS-FET, connects the drain of the P-type MOS-FET to the power input terminal, connects the source to the internal power terminal, and connects the gate to the output of the second control circuit;

the second control circuit inputs the power voltage of the IFPL power input terminal, turns off said P-type MOS-FET when, in a state in which the power voltage of the power input terminal is available, the power voltage of the IFPL power input terminal is obtained, and when the power voltage is not available from the IFPL power input terminal, turns on the P-type MOS-FET.

The power input connector is a power-line-holding type interface connector connected only to a power line.

### (Subsystem)

According to the present invention, there is provided a subsystem which processes an input/output request from a host apparatus. The subsystem comprises:

a power-line-holding type interface;

another interface other than the power-line-holding type interface;

a power-line-holding type interface connector which is provided in correspondence to the power-line-holding type interface and connected to a USB cable having a signal line and a power line;

an interface connector which is provided in correspondence to the other interface, and is connected to a cable having only a signal line;

a power input connector connected from outside to a power cable; and

a power control circuit which outputs power in response to the state of power input from said power-line-holding type interface connector and the power input connector;

wherein the power control circuit comprises: an IFPL power input terminal for input-connecting a power line from the power-line-holding type interface connector;

a power input terminal which input-connects the power line from the power input connector;

an internal power terminal which supplies power to an internal power circuit;

a first changeover circuit which input-connects the IFPL power input terminal, is turned on in response to an input state of the IFPL bus power, supplies the IFPL bus power to the internal power terminal, and cuts off connection to the internal power terminal by being turned off in response to a non-input state of the IFPL bus power;

a diode which is insertion-connected to the position side of the power line connected from the power input terminal to the internal power terminal; and

a second changeover circuit which is parallel-connected to the diode, supplies power of the power input terminal to the internal power terminal via the diode by being turned off in response to an input state of the IFPL bus power, and supplies power from the power input terminal directly to the internal power terminal, while bypassing the diode by being turned on in response to a non-input state of said IFPL bus power.

According to the present invention, in a subsystem having, in addition to a USB interface capable of supplying bus power, another interface not having a supplying function of bus power such as a serial ATA, and determines interfaces to be selectively used through connection of an interface cable, power can be supplied into the subsystem appropriately in response to the state of connection of the interface cable.

More specifically, when using a USB interface in the subsystem, the following first to third modes are automatically established by the cable connection.

The first mode covers a case where the subsystem is connected to a host apparatus by a single USB cable, wherein only bus power is supplied.

The second mode covers a case where the subsystem is connected to a host apparatus by two cables including a USB cable and a power USB cable, wherein two kinds of bus power are supplied in superposition.

The third mode covers a case where the subsystem is connected to a host apparatus by a USB cable, and connected to an AC adapter by a power cable, wherein power is supplied by bus power and the power adapter in superposition.

In the first to third modes using bus power of the USB interface, a diode is always insertion-connected to the power line on the power input connector side. Particularly, the second and the third modes for making up bus power shortage, occurrence of a backward flow of current to the USB port can be prevented by the diode.

When using another interface such as a serial ATA, the following fourth and fifth modes are automatically established by the cable connection.

The fourth mode covers a case where the subsystem is connected to the host apparatus through two cables including the interface cable and a power USB cable, wherein only USB bus power is supplied.

The fifth mode covers a case where the subsystem is connected to the host apparatus with an interface cable, and to an AC adapter with a power cable, wherein only source power is supplied.

In the fourth and the fifth modes, the diode insertion-connected to the power line on the power input connector side is bypassed upon turn-on of the parallel-connected second changeover circuit, to prevent a voltage loss caused by the diode. This can prevent occurrence of a malfunction caused by the source voltage drop when using another interface such as a serial ATA.

The above and other objects, features, and advantages of the present invention will become more apparent from the following detailed description with reference to the drawings.

### BRIEF DESCRIPTION OF THE DRAWINGS

FIG. 1 is a descriptive view illustrating an embodiment of the subsystem of the present invention;

FIG. 2 is a block diagram illustrating the internal configuration of the subsystem of this embodiment;

FIG. 3 is a circuit block diagram of the power control circuit unit shown in FIG. 2;

FIG. 4 is a descriptive view illustrating a list of power control modes by the power control circuit unit shown in FIG. 2;

FIG. 5 is a circuit diagram illustrating an embodiment of the circuit configuration of the power control unit shown in FIG. 3;

FIGS. 6A and 6B are descriptive views of the USB cable and the power USB cable in this embodiment;

FIGS. 7A and 7B are circuit diagrams of the USB cable and the power USB cable shown in FIGS. 6A and 6B;

FIG. 8 is a circuit diagram of the interface cable used in this embodiment;

FIG. 9 is a descriptive view of the state of use in the first mode of this embodiment;

FIG. 10 is a descriptive view of the state of use in the second mode of this embodiment;

FIG. 11 is a descriptive view of the state of use in the third mode of this embodiment;

FIG. 12 is a descriptive view of the state of use in the fourth mode of this embodiment;

FIG. 13 is a descriptive view of the state of use in the fifth mode of this embodiment;

FIG. 14 is a circuit diagram illustrating another embodiment of the circuit configuration of the power control circuit unit shown in FIG. 3; and

FIG. 15 is a circuit diagram illustrating still another embodiment of the circuit configuration of the power control circuit unit shown in FIG. 3.

### DETAILED DESCRIPTION OF THE PREFERRED EMBODIMENTS

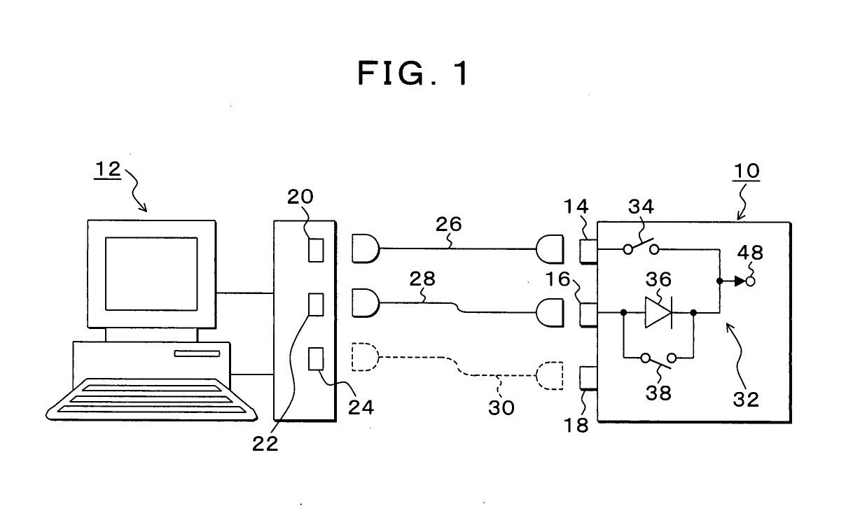

FIG. 1 is a descriptive view illustrating an embodiment of the subsystem having a power control circuit of the present invention. In FIG. 1, the subsystem 10 of this embodiment contains storage devices such as a hard disk drive together with a control circuit thereof built therein. The control circuit of the built-in storage has, in addition to a serial line, and a USB interface which is a power-line-holding type interface having a power line, another interface such as a serial ATA which is a power-line-holding type interface having only a signal line without a power line. The USB interface and, for example, the serial ATA interface are thus separately used through cable-connection to a personal computer 12. A USB connector 14 is provided in correspondence to the USB interface on the outside of a system enclosure of the subsystem 10. An interface connector 18 is provided in correspondence to the serial ATA interface. Furthermore, a power input connector 16 is provided on the outside of the system enclosure. In this embodiment, the same connector as the USB connector 14 is used to permit supply of bus power (USB bus power) by the connection of the USB cable to the power input connector 16. In the interior of the subsystem 10, a first changeover circuit 34, a diode 36 and a second changeover circuit 38 are provided as the power control circuit unit 32. The first changeover circuit 34 and the second changeover circuit 38 are composed of a P-type MOS-FET and a control circuit thereof, as described later. To simplify description, they are simply shown as switches. The details of the circuit configuration and operation of this power control circuit unit 32 will be described later. The subsystem 10 of this embodiment is used by connecting the interface cable to the personal computer 12. Two USB connectors 20 and 22, and an interface connector 24 corresponding to a second interface installed in the subsystem 10 such as a serial ATA interface are provided in the personal computer 12. The subsystem 10 is connected to the personal computer 12 by selectively using a USB cable 26, a power USB cable 28, and an interface cable 30. The subsystem 10 is applied either by using the USB interface, or by using the other interface such as a serial ATA interface. When using, these interfaces are discriminated by selectively connecting the USB cable 26, the power USB cable 28 and the interface cable 30. There are available the first to the fifth modes as modes of use of the subsystem 10 of the embodiment. The states of cable connection in the first to the fifth modes are as follows. In the fist mode, only the USB cable 26 is connected for use of the USB interface of the subsystem 10. In the second mode, for the purpose of using the subsystem 10 with the USB interface and make up bus power shortage, connection is accomplished with the use of the USB cable 26 and the power USB cable 28. In the third mode, for the purpose of using the subsystem 10 with the USB interface and make up power shortage, an AC adapter not shown is cable-connected to the power input connector 16. In the fourth mode, for the purpose of using the subsystem 10 with the serial ATA interface, bus power is supplied by connecting the interface cable 30 and connecting the power USB cable 28 for supply power. In the fifth mode, for the purpose of using the subsystem 10 with a serial ATA interface, the interface cable 30 is connected, and an AC adapter not shown is cable-connected to the power input connector 16 for supplying power. From among these first to fifth modes, in the first to the third modes using the USB interface of the subsystem 10, the first changeover circuit 34 is turned on and the second changeover circuit 38 is turned off. In the first mode, USB bus voltage fed through the USB cable 28 is supplied to the internal power terminal 48. In the second and the third modes, in contrast, USB bus voltage from the USB connector 14 and USB bus power from the power input terminal 16 or power from the AC adapter are supplied in superposition to the internal power terminal 48. In the fourth and the fifth modes in which the serial ATA interface of the subsystem 10 is used by connecting the interface cable 30, on the other hand, powder is supplied through connection of the power USB cable 28 to the power input connector 16 or cable connection from the AC adapter. In this supply of power, the first changeover circuit 34 is turned off and the second changeover circuit 38 is turned on. The diode 36 is bypassed by the turn-on of the second changeover circuit 38, thus ensuring supply of USB bus power from the power input connector 16 or source voltage from the AC adapter to the internal power terminal 48 without causing a voltage loss caused by the diode 36.

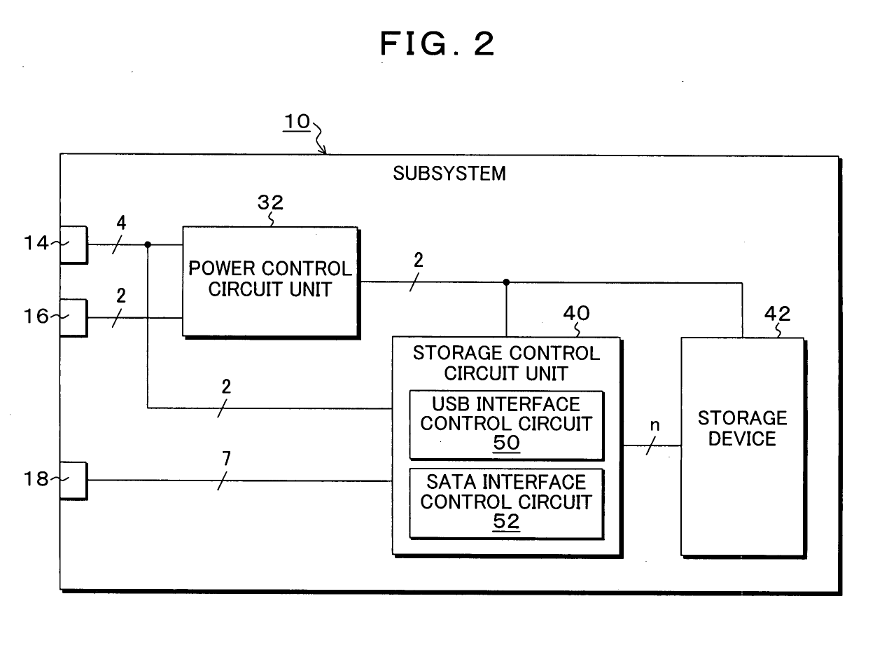

FIG. 2 is a block diagram illustrating the internal configuration of the subsystem 10 of this embodiment. In FIG. 2, a USB connector 14, a power input connector 16 and an interface connector 18 are provided in the subsystem 10, and a power control circuit 32, a storage control circuit 40 and a storage device 42 of this embodiment are provided as internal circuits. The storage device 42 is, for example, a hard disk drive. A USB interface control circuit 50 and another interface such as an SATA interface control circuit 52 are provided in the storage control circuit unit 40 and are connected to the USB connector 14 and the interface connector 18, respectively. Upon cable-connection to the USB cable, the storage control circuit unit 40 is changed over to the USB interface control circuit 50 and performs data transfer with the storage device 42. Upon cable connection to the interface connector 18, it is changed over to the SATA interface control circuit 52 and performs data transfer with the storage device 42. Four signal lines are drawn out from the USB connector 14. Two of these four signal lines are connected to the power control circuit 32, and the remaining two signal lines are connected to the storage control circuit unit 40. Two power lines are derived from the power input connector 16 and are connected to the power control circuit 32. Two power lines for internal power supply are pulled out from the power control circuit 32 and are connected to the storage control circuit unit 40 and the storage device 42, respectively, to supply internal power. For example, seven signal lines are drawn out from the interface connector 18, and are connected to the storage control circuit unit 40. The seven signal lines drawn out from the interface connector 18, in the case of an SATA interface, comprise two receiving signal lines, two transmitting signal lines, and three grounding lines. The signal line between the storage control circuit unit 40 and the storage device 42 is, for example, a bus, and n buses corresponding to the number of bus bit number are used.

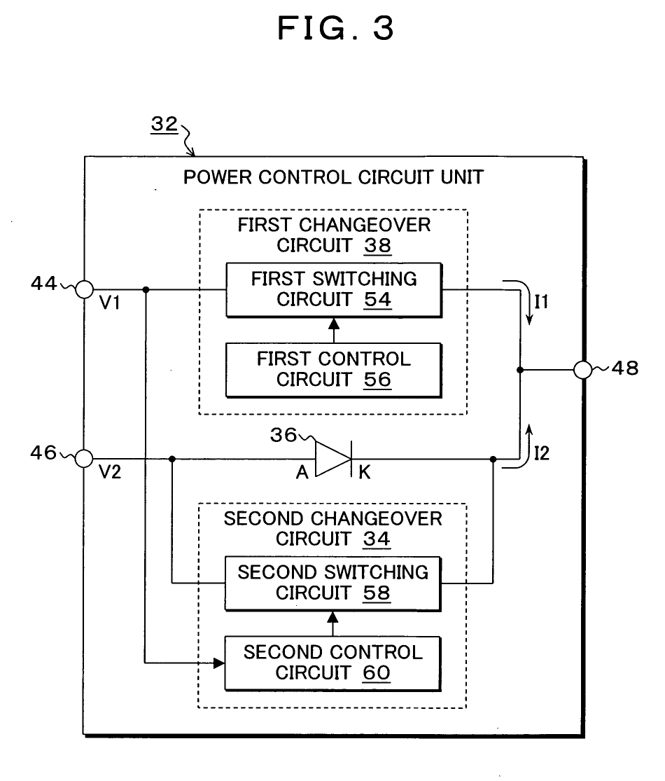

FIG. 3 is a circuit block diagram of the power control circuit unit 32 shown in FIG. 2. A USB power input terminal 44, a power input terminal 46 and an internal power terminal 48 are provided in the power control circuit 32. The two power lines from the USB connector 14 are connected to the USB input terminal 44 as shown in FIG. 2. The two power lines from the power input connector 16 shown in FIG. 2 are connected to the power input terminal 46. As shown in FIG. 2, two power lines to the storage control circuit unit 40 and the storage device 42 are pulled out from the internal power terminal 48. A first changeover circuit 34 and a second changeover circuit 38 are provided in the power control circuit 32. The first changeover circuit 34 is composed of a first switching circuit 54 and a first control circuit 56. The second changeover circuit 38 comprises a second switching circuit 58 and a second control circuit 60. The first switching circuit 54 of the first changeover circuit 34 is insertion-connected to the power line connecting the USB power input terminal 44 and the internal power terminal 48. The first control circuit 56 controls the first switching circuit 54 by inputting USB bus power to the USB power input terminal 44. The second switching circuit 58 of the second changeover circuit 38 is parallel-connected to the diode 36 insertion-connected to the positive side of the power line connecting the power input terminal 46 and the internal power terminal 48. The diode 36 connects the anode side to the power input terminal 46 and connects the cathode side to the internal power terminal 48 side to which the output from the first switching circuit 54 is connected. The second switching circuit 58 is controlled by the second control circuit 60, and USB bus power from the USB power input terminal 44 is inputted into the second control circuit 60.

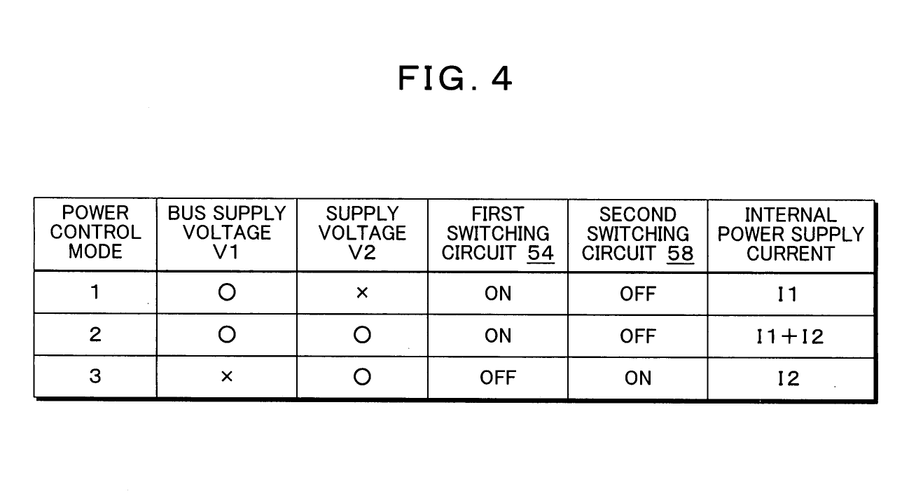

FIG. 4 is a descriptive view list-showing operations by the power control circuit unit shown in FIG. 3 by dividing them into power control modes. In FIG. 4, there are three power control modes including modes 1 to 3. The power control mode 1 covers a case where connection is based on only the USB cable, wherein a bus source voltage 1 is available from the USB power input terminal 44, and a power voltage V2 is unavailable from the power input terminal 46. The first control circuit 56 turns on the first switching unit 54. On the other hand, the second switching circuit 58 is turned off by the second control circuit 60, and only current 11 based on bus source voltage V1 is supplied to the internal power terminal 48. The power control mode 2 covers a case where, in addition to the USB cable, a power USB cable or an AC adapter is connected, wherein bus source voltage V1 is available from the USB power input terminal 44, and source voltage V2 is also available from the power input terminal 46. In this case, the first switching circuit 54 is turned on and the second switching circuit 58 is turned off since the first control circuit 56 and the second control circuit 60 operate by input of the bus source voltage V1. As a result, bus source voltage V1 of the USB power input terminal 44 is supplied to the internal power terminal 48 via the first switching circuit 54. On the other hand, source voltage V2 of the power input terminal 46 is supplied to the internal power terminal 48 via the diode 36 since the second switching circuit 58 is turned off. Internal source current from the internal power terminal 48 results in supply of current (I1+I2) obtained by the addition of I1 corresponding to bus source voltage V1 and current I2 corresponding to source voltage V2, thus making it possible to increase the power supply capability. Both the power control modules 1 and 2 cover a case of using the USB interface in the subsystem 10. On the other hand, the power control mode 3 covers a case where a serial ATA interface which is another interface is used in the subsystem. In this case bus source voltage V1 is unavailable from the USB power input terminal 44, and only source voltage v2 resulting from connection of the power USB cable from the power input terminal 46 or the power cable of the AC adapter is supplied. The first control circuit 56 therefore turns off the first switching circuit 54 since bus source voltage V1 is unavailable. The second control circuit 60 turns on, on the other hand, the second switching circuit 58 since bus source voltage V1 is unavailable, and bypasses the diode 36. As a result, source voltage V2 of the power input terminal 46 is supplied to the internal power terminal 48 without causing a loss through bypassing of the diode 36 due to the second switching circuit 58, thus permitting supply of I2 corresponding to source voltage V2 as internal source current. Supply of current I2 to the internal power terminal 48 is accomplished through supply of USB bus power through the power USB cable, or bus power is in shortage, through power supply by connecting with a power cable to the AC adapter.

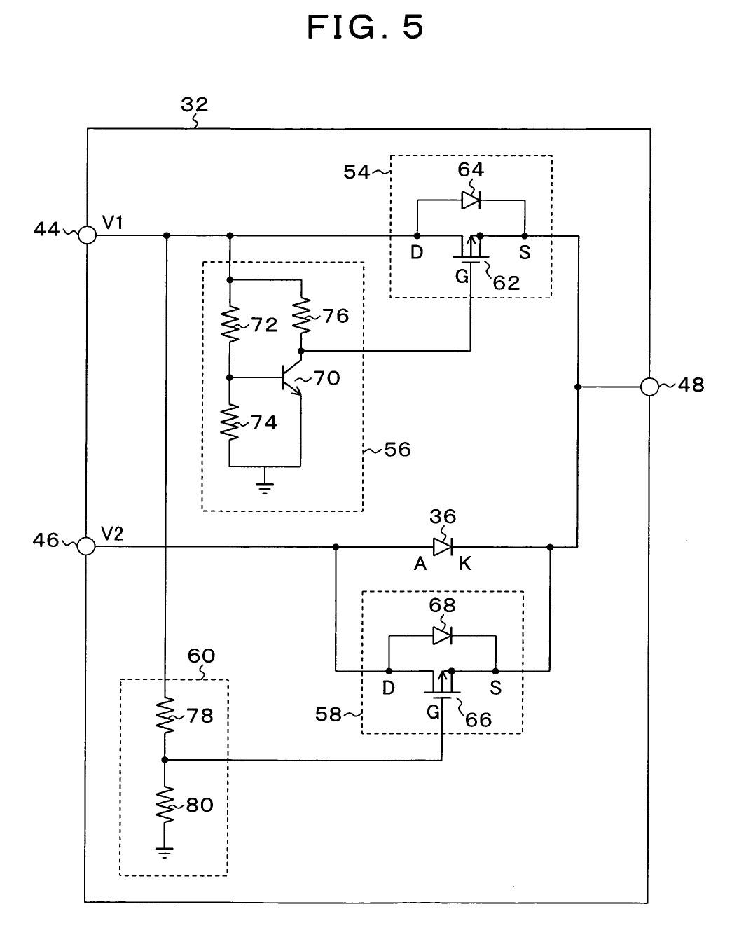

FIG. 5 is a circuit diagram illustrating an embodiment of the circuit configuration in the power control circuit 32 shown in FIG. 3. In FIG. 5, a P-type MOS-FET 62 is provided in the first switching circuit 54 provided in the power control circuit unit 32. The P-type MOS-FET 62 connects the drain D to the USB power input terminal 44, connects the source S to the internal power terminal 48, and connects the gate G to the control output of the first control circuit 56. The P-type MOS-FET has a parasitic diode 64 because of its element structure. The parasitic diode 64 is parallel-connected with its anode A on the drain D side and its cathode K on the source S side. The first control circuit 56 is composed of an NPN transistor 70 and resistances 72, 74 and 76. The first control circuit 56 turns on the NPN transistor 70 by dividing the bus source voltage V1 of the USB power input terminal 44 by means of the resistances 72 and 74, and supplying the divided voltage to the base of the NPN transistor. Control output of the first control circuit 56 becomes an H-level output when the transistor 70 is turned off. Application of the H-level output to the gate of the P-type MOS-FET 62 brings about a high impedance state between the drain and the source, leading to a so-called switch-off state. When the NPN transistor 70 is turned on, the control output is drawn into the L-level, leading to a low-impedance state between the drain and the source, resulting in a so-called switch-on state. A P-type MOS-FET 66 is provided similarly in the second switching circuit 58, connecting the drain D and the source S in parallel with the diode 36. A parasitic diode 68 is existent in the P-type MOS-FET 66 and is parallel-connected between the drain and the source. The second control circuit 60 is a voltage dividing circuit serially connecting the resistances 78 and 80, and supplies divided bus source voltage of the USB power input terminal 44 to the gate G of the P-type MOS-FET 60. As a result, application of bus source voltage V1 to the USB power input terminal 44 brings the gate to an H-level under the effect of divided voltage from the second control circuit 60, leading to a high-impedance state between the drain and the source of the P-type MOS-FET 66, resulting in the switch-off state. On the other hand, when supply of power to the USB power input terminal 44 is discontinued, cutting off bus source voltage V1, output of the second control circuit 60 becomes L-level, leading to the low-impedance state between the drain and the source of the P-type MOS-FET 66, thus resulting in the switch-on state.

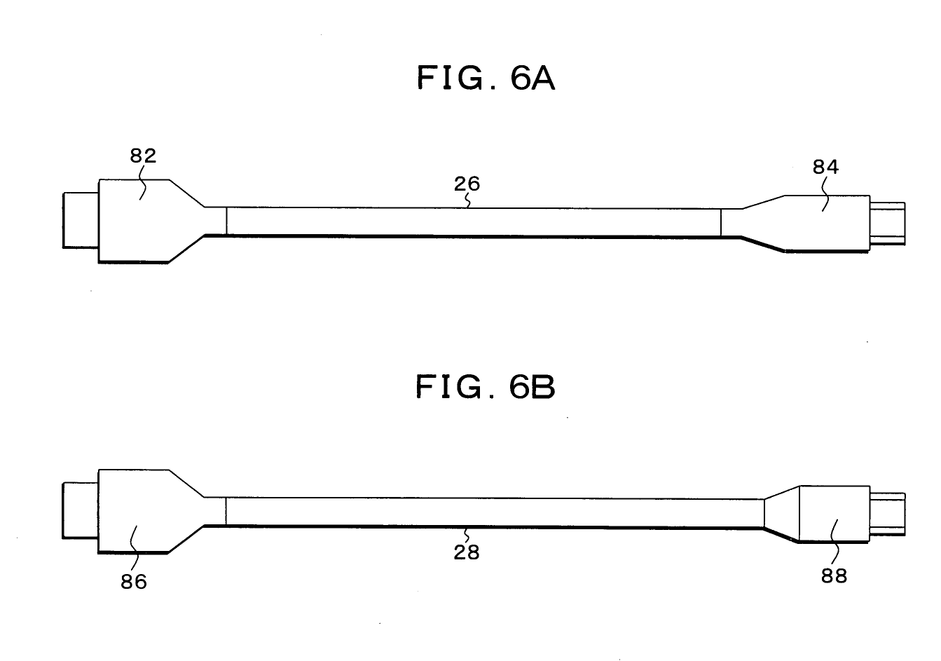

FIGS. 6A and 6B are descriptive views of the USB cable 26 and the power USB cable 28 used in this embodiment. FIG. 6A illustrates the USB cable 26. An A-type USB connector 82 connecting to the USB connector 20 of the personal computer 12 shown in FIG. 1 is provided at an end thereof, and a B-type USB connector 84 connecting to the USB connector 14 of the subsystem 10 shown in FIG. 1 is provided at the other end. For the power USB cable 28 shown in FIG. 6B as well, an A-type connector 86 connecting to the USB connector 22 of the personal computer 12 shown in FIG. 1 provided at an end thereof, and a B-type USB connector 88 connecting to the power input connector 16 of the subsystem shown in FIG. 1 is provided at the other end. The connector 88 connected to the power input connector 16 may be of the general DC jack type.

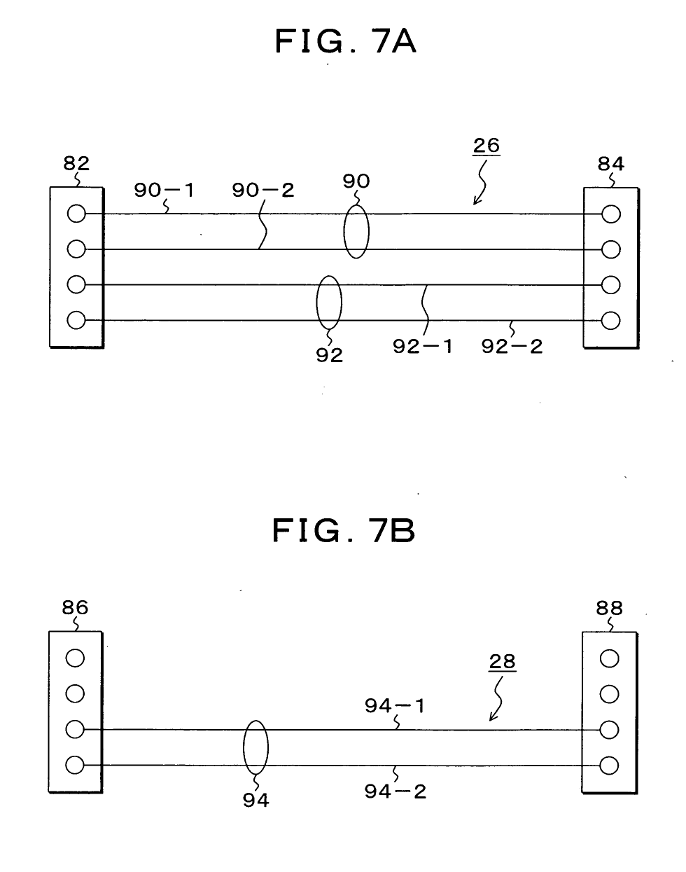

FIGS. 7A and 7B are circuit diagrams of the USB cable 26 and the power USB cable 28 shown in FIGS. 6A and 6B. FIG. 7A illustrates the USB cable 26, comprising two signal lines 90 and power lines 92. The signal lines 90 are composed of a positive signal line (+ DATA line) 90-1 and a negative signal line (− DATA line) 90-2. The power lines 92 are composed of a positive power line (VDD li92-1 and a negative power line (GND line) 92-2. FIG. 7B illustrates the power USB cable 28. It has a configuration in which the signal line 90 is excluded from the USB cable 26 shown in FIG. 7A, and composed of only a power line 94. The power line 94 has a positive line (VDD line) 94-1 and a negative power line (GND line) 94-2.

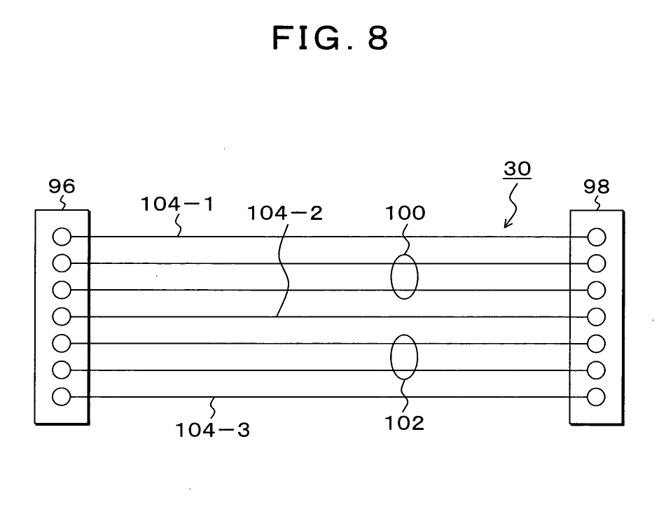

FIG. 8 illustrates the interface cable 30 used in this embodiment, representing a case where it is used for a serial ATA interface, showing a one-lane configuration. The one-lane interface cable 30 is composed of a receiving signal line 100 having two signal lines and a transmitting signal line 102 having similarly two signal lines. In addition to these signal lines, three grounding lines 104-1 to 104-3 are provided.

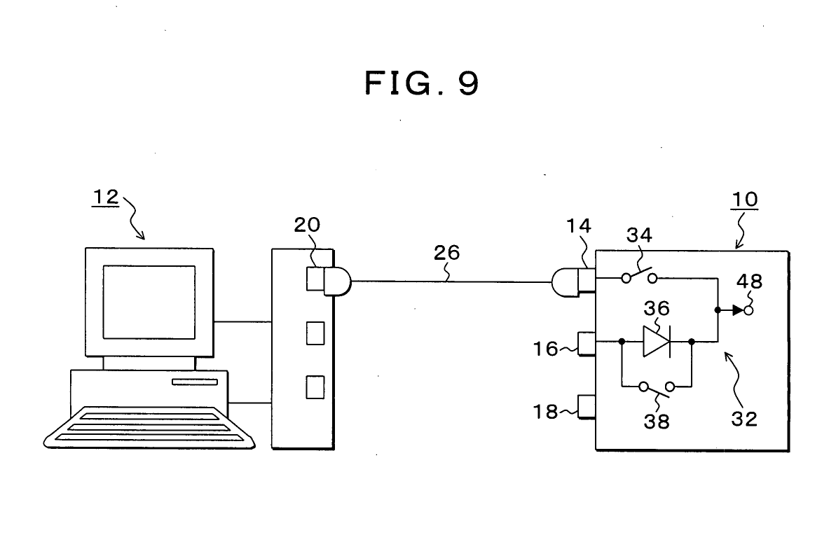

The states of use of the first to the fifth modes based on cable connection in the embodiment of the present invention will now be described. FIG. 9 illustrates the state of use of the first mode when connection is accomplished only with the USB cable 26. That is, the USB connector 20 of the personal computer 12 and the USB connector 14 of the subsystem 10 are connected with only the USB cable 26. Connection of this USB cable 26 causes supply of USB bus power to the power lines of the USB connector 14, leading to turn-on of the first changeover circuit 34, and supply of the USB bus power supplied by the USB cable 26 to the internal power terminal 48.

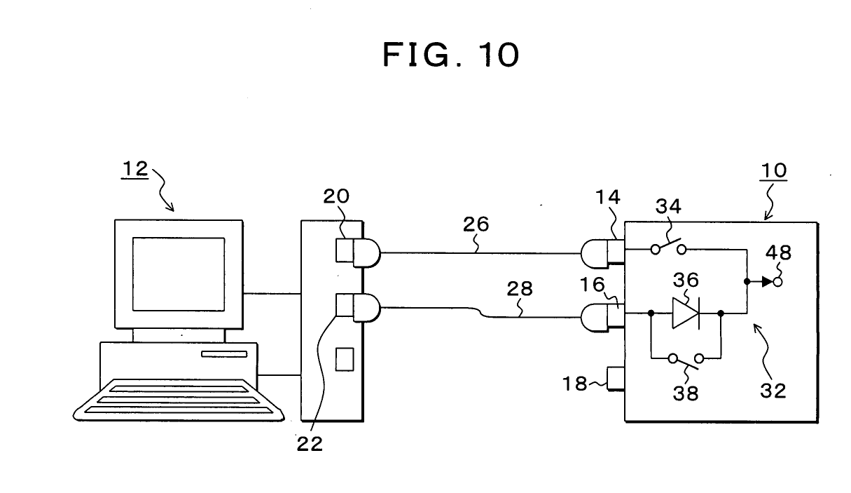

FIG. 10 illustrates the state of use in the second mode of this embodiment in which connection is accomplished with the USB cable and the power USB cable. In the state of use in the second mode, the USB interface of the subsystem 10 is used. The USB connector 20 of the personal computer 12 and the USB connector 14 of the subsystem 10 are therefore connected with the USB cable 26. For the purpose of making up shortage of bus power through the USB cable 26, the USB connector 22 of the personal computer 12 and the power input connector 16 of the subsystem 10 are connected with the power USB cable 28. As a result of this connection of the USB cable 26 and the power USB cable 28, supply of USB bus power to the USB connector 14 in the power control circuit unit 32 of the subsystem 10 causes turn-on of the fist changeover circuit 34 whereas the second changeover circuit 38 is turned off. USB bus power is supplied through the USB cable 26 to the internal power terminal 48, and at the same time, USB bus power received from the power USB cable 28 is supplied in superposition to the internal power terminal 48 via the reflux preventing diode 36, thereby making up supply shortage of power.

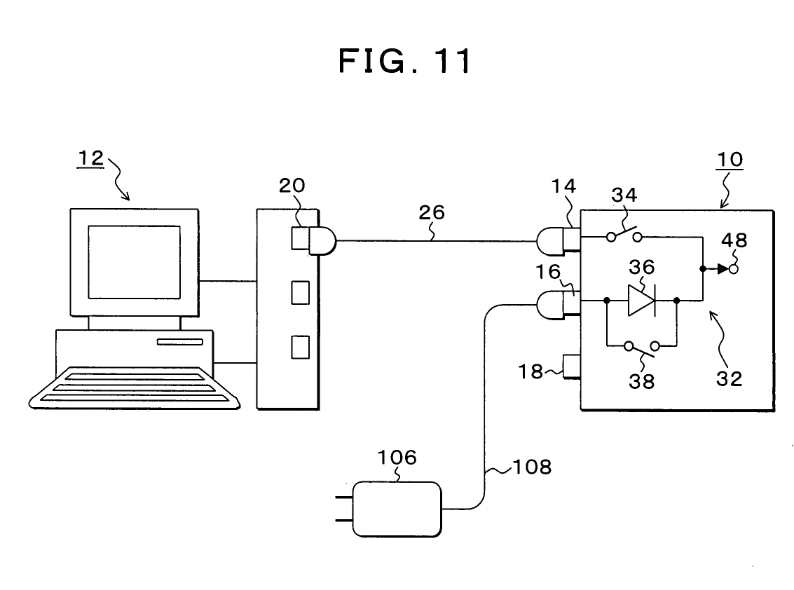

FIG. 11 is a descriptive view of a state of use in the third mode in this embodiment. In the state of use in the third mode, the USB connector 20 of the personal computer 12 and the USB connector 14 of the subsystem 10 are connected with the USB cable 26 since the USB interface of the subsystem 10 is used. To make up shortage of the USB bus power through the USB cable 26, the AC adapter 106 is connected to the power input connector 16 of the subsystem 10 with the power cable 108. The AC adapter 106 is connected to an AC plug socket, to output commercial AC power after converting it into DC power of the same voltage as that of the USB bus power. In this case, the power control circuit unit 32 of the subsystem 10 is supplied with USB bus power through the USB cable 26. The first changeover circuit 34 is turned on, and the second changeover circuit 38 is turned off. This is the same as in the second mode shown in FIG. 10: USB power brought through the USB cable 26 and power coming from the AC adapter 106 are supplied to the internal power terminal 48 via the diode 36 in superposition, and shortage of USB bus power is made up with supply of power from the AC adapter 106. Since the adapter 106 has a sufficient power supplying capability in the third mode, the third mode should be used when power supply is in short with the supply of USB bus power of two channels in the second mode shown in FIG. 10.

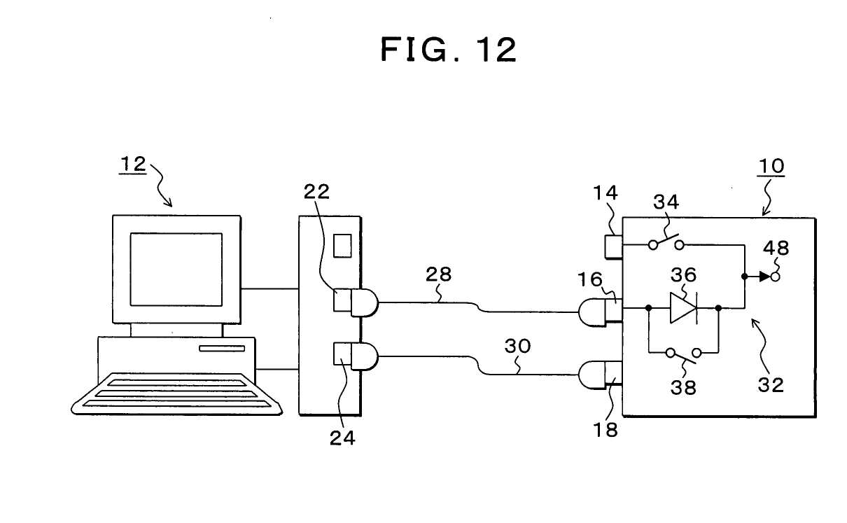

FIG. 12 illustrates the state of use in the fourth mode in the present embodiment. In the state of use in the fourth mode, the other interface of the subsystem 10 such as a serial ATA interface is used. The interface connector 24 of the personal computer 12 and the interface connector 18 of the subsystem 10 are therefore connected with the interface cable 30. For the supply of power which permits operation of the serial ATA interface, the USB connector 22 of the personal computer 12 and the power input connector 16 of the subsystem 10 are connected with the power USB cable 28. In this state of cable connection, the supply of USB bus power to the USB connector 14 in the power control circuit unit 32 of the subsystem 10, the first changeover circuit 34 is turned off. The second changeover circuit 38 is turned on in contrast, and the diode 36 is bypassed. As a result, the USB bus power supplied through the power USB cable 28 bypasses the diode 36, and is supplied to the internal power terminal 48 without causing a voltage loss, through the second changeover circuit 38.

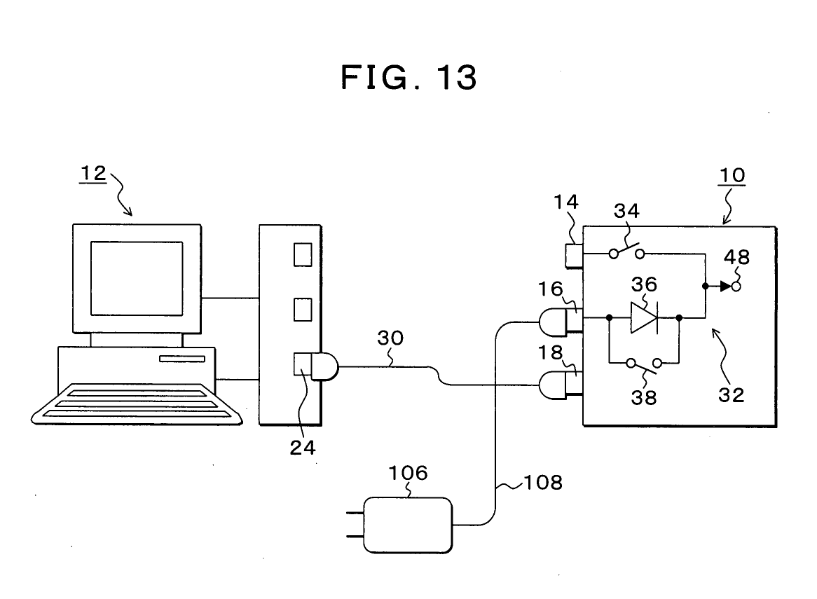

FIG. 13 illustrates the state of use in the fifth mode in the present embodiment. In the state of use in the fifth mode, the serial ATA interface of the subsystem is used. The interface connector 24 of the personal computer 12 and the interface connector 18 of the subsystem 10 are connected with the interface cable 30. Supply of USB bus power through the connection with the power USB cable 28 in the fourth mode shown in FIG. 12 is not sufficient, the power cable 108 from the AC adapter 106 is connected to the power input connector 16. Operation of the power control circuit unit 32 of the subsystem 10 in the fifth mode is the same as in the fourth mode. Since USB bus power is not supplied to the USB connector 14, the first changeover circuit 34 is turned off, and the second changeover circuit 38 is turned on, and power from the AC adapter 106 is supplied to the internal power terminal 48 via the second changeover circuit 38, bypassing the diode 36, without causing a voltage loss.

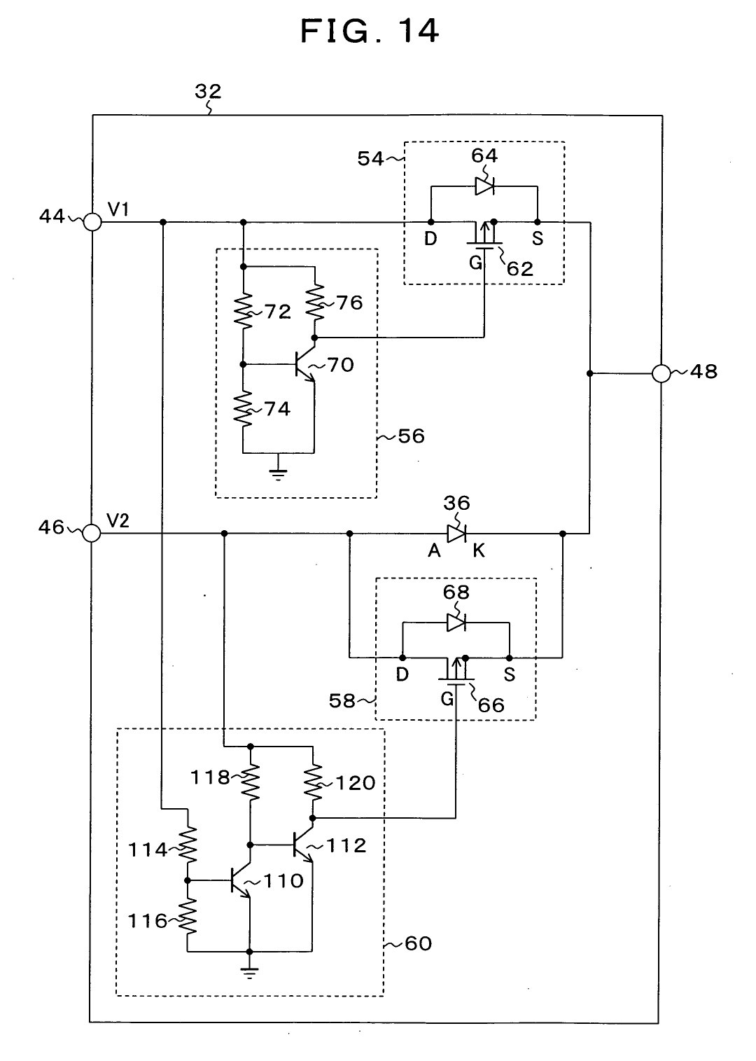

FIG. 14 is a circuit diagram illustrating another embodiment of the circuit configuration in the control circuit unit shown in FIG. 3. In FIG. 14, the first switching circuit 54 and the first control circuit 56 composing the first changeover circuit 34 of the power control circuit unit 32 are the same as those in the embodiment shown in FIG. 5. On the other hand, the second switching circuit 58 composing the second changeover circuit 38 is the same as in FIG. 5. In this embodiment, the second control circuit 60 is composed of two stages of transistor circuits including NPN transistors 110 and 112, and resistances 114, 116, 118 and 120. Operation of the second control circuit 60 is as follows. When bus source voltage V1 is supplied to the USB power input terminal 44, the NPN transistor 110 is turned on through voltage division of the resistances 114 and 116. The base leading-in along with this, the NPN transistor 112 is turned off, and source voltage V2 applied to the power input terminal 46 is impressed onto the gate of the P-type MOS-FET 66 as an H-level output. With a high impedance between the source and the drain of the P-type MOS-FET 66, a switched-off state results. In a state in which bus source voltage V1 is supplied to the USB power input terminal 44, and source voltage V2 is supplied to the power input terminal 46, the NPN transistor 110 is turned on and the NPN transistor 112 under the effect of bus source voltage V1. Supply of source voltage V2 via the resistance 120 leads to an H level of the gate of the P-type MOS-FET 66. As a result, the P-type FOS-FET 66 is brought to a high impedance state, and the switch-off state results. Furthermore, when bus source voltage V1 is not supplied to the USB power input terminal 44 and source voltage V2 is supplied only to the power input terminal 46, the NPN transistor 110 of the second control circuit 60 is turned off. As a result, turning-on of the NPN transistor 112 brings the gate of the P-type MOS-FET 66 to an L level, leading to a low impedance between the source and the drain of the P-type MOS-FET 66, this resulting in the switch-on state, causing bypassing of the diode 36. The other operations are the same as in the embodiment shown in FIG. 5.

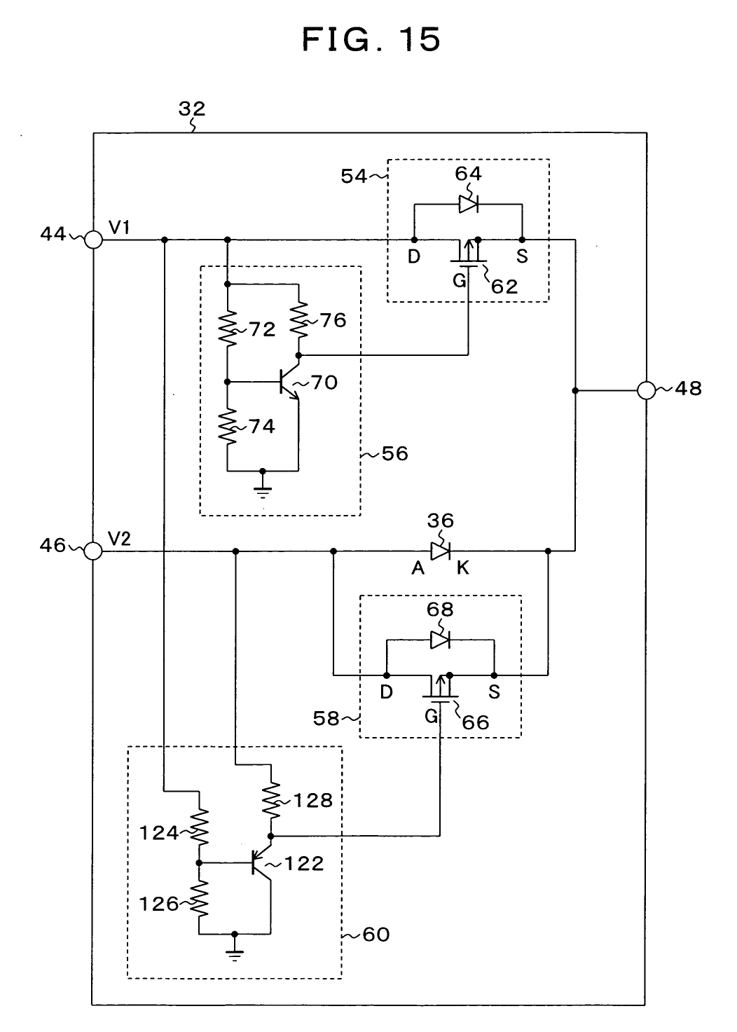

FIG. 15 is a circuit diagram illustrating another embodiment of the circuit configuration of the power control circuit unit shown in FIG. 3. In FIG. 15, the first switching circuit 54 and the first control circuit 56 composing the first changeover circuit 34 in the power control circuit unit 32 are the same as those in the embodiment shown in FIG. 3. The second switching circuit 58 composing the second changeover circuit 38 is also the same as in the embodiment shown in FIG. 3, the only difference is the second control circuit 60. In the present embodiment, the second control circuit 60 is composed of a PNP transistor 122 and resistances 124, 126 and 128. Operation of the second control circuit 60 is as follows. If bus source voltage V1 is supplied to the USB power input terminal 44 and source voltage V2 is not supplied to the power input terminal 46, the P-type MOS-FET 66 cannot bypass the diode 36 and is in the switch-off state. On the other hand, in a state in which bus source voltage V1 is supplied to the USB power input terminal 44 and source voltage V2 is supplied to the power input terminal 46, the NPN transistor 122 is turned off under the effect of bus source voltage V1. However, supply of source voltage V2 via the resistance 128 brings the gate of the P-type MOS-FET 66 to an H level, resulting in a high impedance of the P-type MOS-FET 66 and the switch-off state. When bus source voltage V1 is not supplied to the USB power input terminal 44 and source voltage V2 is supplied only to the power input terminal 46, the base bias of the PNP transistor 122 is cancelled, bringing about the turn-on state. L-level output is supplied to the P-type MOS-FET by drawing the emitter into grounding, this leading to a low impedance of the P-type MOS-FET, and the resultant switch-on state permits bypassing of the diode 36. In the foregoing embodiments, a serial ATA interface as another interface other than the USB interface has been used. This may be any appropriate interface which does not obtain bus power as in a USB interface but requires power supply through connection with a special power cable. The aforementioned embodiments have been described by means of a USB interface in compliance with the USB Standard, however, the present invention is applicable also to the extended USB Standard to be revised hereafter. The present invention is applicable also to interfaces of the power-line-holding type (power supply type) standards having other power lines such as IEEE1394. In the above-mentioned embodiments, a personal computer has been used as an example as a host apparatus. However, any appropriate apparatus externally connecting to a subsystem can be an object of the present invention. The present invention includes appropriate variations without impairing the object and advantages thereof, and is not limited by numerical values shown in the aforementioned embodiments.

What is claimed is:

1. A power control circuit of a subsystem having, in addition to a lower-line-holding type interface, another interface, and in addition to two interface connectors corresponding to said two interfaces, a power input connector, comprising:
an IFPL power input terminal for input-connecting a power line from said power-line-holding type interface connector;
a power input terminal which input-connects the power line from said power input connector;
an internal power terminal which supplies power to an internal power circuit;
a first changeover circuit which input-connects said IFPL power input terminal, is turned on in response to an input state of the IFPL bus power, supplies said IFPL bus power to said internal power terminal, and cuts off connection to said internal power terminal by being turned off in response to a non-input state of said IFPL bus power;
a diode which is insertion-connected to the position side of the power line connected from said power input terminal to said internal power terminal; and
a second changeover circuit which is parallel-connected to said diode, supplies power of said power input terminal to said internal power terminal via said diode by being turned off in response to an input state of said IFPL bus power, and supplies power from said power input terminal directly to said internal power terminal, while bypassing said diode by being turned on in response to a non-input state of said IFPL bus power.

2. A power control circuit of a subsystem according to claim 1, wherein:
when IFPL bus power is impressed on said IFPL power input terminal by connecting a cable from a host apparatus only to said power-line-holding type interface connector for using the power-line-holding type interface in said subsystem,
said first changeover circuit is turned on in response to input of said IFPL bus power, and only IFPL bus power of said IFPL power input terminal is outputted to said internal power terminal by turning off said second changeover circuit.

3. A power control circuit of a subsystem according to claim 1, wherein:
when an IFPL cable having a power line and signal line from a host apparatus is connected to said power-line-holding type interface connector and a power IFPL cable having only a power line from said host apparatus is connected to said power input connector,
said first changeover circuit is turned on in response to input of the IFPL bus power of said IFPL power input terminal while turning off said second changeover circuit, and IFPL bus power of said IFPL power input terminal is outputted directly to said internal power terminal while outputting in superposition IFPL bus power of said power input terminal to said internal power terminal via said diode.

4. The power control circuit of a subsystem according to claim 1, wherein:
when, for the purpose of using a power-line-holding type interface in said subsystem, connecting an IFPL cable having a power line and a signal line from the host apparatus to said power-line-holding type interface connector, and connecting a power cable from a power adapter which converts AC power into DC power to said power input connector,
said first changeover circuit is turned on and said second changeover circuit is turned off in response to input of the bus power of said power input terminal; IFPL bus power of said IFPL power input terminal is outputted directly to said internal power terminal and power of said power input terminal is outputted in superposition to said internal power terminal.

5. The power control circuit of the subsystem according to claim 1, wherein:
when, for the purpose of using another interface in said subsystem, connecting a cable of another interface from the host apparatus to said other interface connector, and connecting a power IFPL cable having only a power line from said host apparatus to said power input connector,
said first changeover circuit is turned off and said second changeover circuit is turned on in response to non-input of IFPL bus power of said IFPL power input terminal; IFPL bus power of said power input terminal is bypassed and outputted directly to said internal power terminal.

6. The power control circuit of the subsystem according to claim 1, wherein:
when, for the purpose of using another interface in said subsystem, connecting a cable of another interface from the host apparatus to said other interface connector, and connecting a power cable from a power adapter which converts AC power into DC power to said power input connector,
said first changeover circuit is turned off and said second changeover circuit is turned on in response to non-input of IFPL bus power of said IFPL power input terminal; and power of said power input terminal is directly outputted to said internal power terminal by bypassing said diode.

7. The power control circuit according to claim 1, wherein:
said first changeover circuit has a first switching circuit and a first control circuit;
said first switching circuit has a P-type MOS-FET; the drain of said P-type MOS-FET is connected to said IFPL power input terminal; the source is connected to said internal power terminal; and the gate is connected to the output of said first control circuit;
said first control circuit inputs a power voltage of said IFPL power input terminal, and when said power voltage is obtained, turns on said P-type MOS-FET;
said second changeover circuit has a second switching circuit and a second control circuit;
said second switching circuit has a P-type MOS-FET, connects the drain of said P-type MOS-FET to said power input terminal, connects the source to said internal power terminal, and connects the gate to the output of said second control circuit;
said second control circuit inputs the power voltage of said IFPL power input terminal, turns off said P-type MOS-FET when, in a state in which the power voltage of said power input terminal is available, said power voltage of said IFPL power input terminal is obtained, and when said power voltage is not available from said IFPL power input terminal, turns on said P-type MOS-FET.

8. The power control circuit of the subsystem according to claim 1, wherein said power input connector is a power-line-holding type interface connector connected only to a power line.

9. The power control circuit of the subsystem according to claim 1, wherein said other interface includes a serial ATA interface.

10. A subsystem which processes an input/output request from a host apparatus, comprising:
a power-line-holding type interface;
another interface other than said power-line-holding type interface;
a power-line-holding type interface connector which is provided in correspondence to said power-line-holding type interface and connected to a USB cable having a signal line and a power line;
an interface connector which is provided in correspondence to said other interface, and is connected to a cable having only a signal line;
a power input connector connected from outside to a power cable; and
a power control circuit which outputs power in response to the state of power input from said power-line-holding type interface connector and said power input connector;
wherein said power control circuit comprises: an IFPL power input terminal for input-connecting a power line from said power-line-holding type interface connector;
a power input terminal which input-connects the power line from said power input connector;
an internal power terminal which supplies power to an internal power circuit;
a first changeover circuit which input-connects said IFPL power input terminal, is turned on in response to an input state of the IFPL bus power, supplies said IFPL bus power to said internal power terminal, and cuts off connection to said internal power terminal by being turned off in response to a non-input state of said IFPL bus power;
a diode which is insertion-connected to the position side of the power line connected from said power input terminal to said internal power terminal; and
a second changeover circuit which is parallel-connected to said diode, supplies power of said power input terminal to said internal power terminal via said diode by being turned off in response to an input state of said IFPL bus power, and supplies power from said power input terminal directly to said internal power terminal, while bypassing said diode by being turned on in response to a non-input state of said IFPL bus power.

11. The subsystem according to claim 10, wherein:
when, for the purpose of using said power-line-holding type interface, connecting an IFPL cable from the host apparatus only to said power-line-holding type interface connector to impress an IFPL bus power onto said IFPL power input terminal,
said power control circuit turns on said first changeover circuit in response to input of said IFPL bus power, turns off said second changeover circuit, and outputs only the IFPL bus power of said IFPL power input terminal to said internal power terminal.

12. The power control circuit of the subsystem according to claim 10, wherein:
when, for the purpose of using said power-line-holding type interface, connecting the IFPL cable having a power line and a signal line from a host apparatus to said power-line-holding interface connector, and the power IFPL cable having only a power line from said host apparatus to said power input connector,
said power control circuit turns on said first changeover circuit in response to input of the IFPL bus power of said IFPL power input terminal, turns off said second changeover circuit, outputs the IFPL bus power of said IFPL power input terminal directly to said internal power terminal, and outputs the IFPL bus power of said power input terminal in superposition to said internal power terminal via said diode.

13. The subsystem according to claim 10, wherein:
when, for the purpose of using said power-line-holding type interface, connecting an IFPL cable having a power line and a signal line from the host apparatus to said power-line-holding type interface connector, and the power cable from a power adapter which converts AC power into DC power to said power input connector,
said power control circuit turns on said first changeover circuit and turns off said second changeover circuit in response to input of the IFPL bus power of said IFPL power input terminal, outputs IFPL bus power of said IFPL power input terminal directly to said internal power terminal, and output power of said power input terminal in superposition to said internal power terminal via said diode.

14. The subsystem occurring to claim 10, wherein:
when, for the purpose of using said other interface, connecting the cable of the other interface from the host apparatus to said other interface connector, and connecting a power IFPL cable having only a power line from said host apparatus to said power input connector,
said power control circuit turns off said first changeover circuit and turns on said second changeover circuit in response to non-input of IFPL bus power of said IFPL power input terminal, and outputs IFPL bus power of said power input terminal directly to said internal power terminal by bypassing said diode.

15. The subsystem according to claim 10, wherein:
when, for the purpose of using said other interface, connecting the cable of the other interface from the host apparatus to said other interface connector, and connecting a power cable from a power adapter which converts AC power into DC power to said power input connector,
said power control circuit turns off said first changeover circuit and turns on said second changeover circuit in response to non-input of IFPL bus power of said IFPL power input terminal, and outputs power of said power input terminal directly to said internal power terminal by bypassing said diode.

16. The subsystem according to claim 10, wherein:
said first changeover circuit has a first switching circuit and a first control circuit;
said first switching circuit has a P-type MOS-FET, connects the drain of said P-type MOS-FET to said IFPL power input terminal, connects the source to said internal power terminal, and further, connects the gate to the output of said first control circuit;
said first control circuit inputs source voltage of said IFPL power input terminal, and when said source voltage is available, turns on said P-type MOS-FET;
said second changeover circuit has a second switching circuit and a second control circuit;
said second switching circuit has a P-type MOS-FET, connects the drain of said P-type MOS-FET to said power input terminal, connects the source to said internal power terminal, and further, connects the gate to the output of said second control circuit;
said second control circuit inputs source voltage of said IFPL power input terminal, turns off said P-type MOS-FET when said source voltage of said IFPL power input terminal is available in a state in which source voltage of said power input terminal is available, and turns on said P-type MOS-FET when said source voltage is unavailable from said IFPL power input terminal.

17. The subsystem according to claim 10, wherein:
said power input connector is a power-line-holding type interface connector connecting only to a power line.

18. The subsystem according to claim 10, wherein:
said other interface includes a serial ATA interface.
